(19) United States
(12) Patent Application Publication
(10) Pub. No.: US 2017/0053237 A1
(43) Pub. Date: Feb. 23, 2017

(54) METHOD AND SYSTEMS FOR SHARING PARTNERSHIP DATA IN SHIPPING TRANSACTIONS

(71) Applicants: John Lozito, Encinitas, CA (US); Joonyoul Choi, San Diego, CA (US)

(72) Inventors: John Lozito, Encinitas, CA (US); Joonyoul Choi, San Diego, CA (US)

(73) Assignee: Trakkx COM LLC, Encinitas, CA (US)

(21) Appl. No.: 15/243,660

(22) Filed: Aug. 22, 2016

Related U.S. Application Data
(60) Provisional application No. 62/209,594, filed on Aug. 25, 2015.
(60) Provisional application No. 62/208,503, filed on Aug. 21, 2015.
(60) Provisional application No. 62/277,701, filed on Jan. 12, 2016.
(60) Provisional application No. 62/277,709, filed on Jan. 12, 2016.

(51) Int. Cl. G06Q 10/08

(52) U.S. Cl. CPC G06Q 10/0835

(57) ABSTRACT

Systems, methods, and apparatuses are presented for establishing partnerships and generally providing prioritized and/or preferential treatment to various entities in the shipping supply chain of the trucking freight industry for shipping transactions. Various functionality and communications may be enhanced when partnerships are formed. In some embodiments, a freight management website is architected to implement innovative partnership concepts among various freight management companies to realize social network elements tailored for the logistics industry. Freight management companies can configure their preferred business partners so that they can set exactly what and how to share their business target information. Through partnerships, complex logistics business workflow is automated and optimized for trusted freight management companies.

### CROSS REFERENCE TO RELATED APPLICATIONS

This application claims the benefits of U.S. Provisional Application 62/209,594, filed Aug. 25, 2015, and titled, “METHODS AND SYSTEMS FOR MANAGING SHIPPING TRANSACTIONS,” U.S. Provisional Application 62/208,503, filed Aug. 21, 2015, and titled, “METHODS AND SYSTEMS FOR SHARING PARTNERSHIP DATA IN SHIPPING TRANSACTIONS,” U.S. Provisional Application 62/277,701, filed Jan. 12, 2016, and titled, “METHODS AND SYSTEMS FOR FACILITATING SHIPPING TRANSACTIONS IN VIRTUAL DASHBOARD,” and U.S. Provisional Application 62/277,709, filed Jan. 12, 2016, and titled, “METHODS AND SYSTEMS FOR TRACKING ASSETS OF SHIPPING TRANSACTIONS IN REAL TIME,” the disclosures of which are incorporated herein by reference in their entireties and for all purposes.

This application is also related to US non provisional applications (Attorney Docket No. 1402872.00006_TRX006), titled “METHODS AND SYSTEMS FOR MANAGING SHIPPING TRANSACTIONS,” (Attorney Docket No. 1402872.00008_TRX008), titled “METHODS AND SYSTEMS FOR FACILITATING SHIPPING TRANSACTIONS IN VIRTUAL DASHBOARD,” and (Attorney Docket No. 1402872.00009_TRX009), titled “METHODS AND SYSTEMS FOR TRACKING ASSETS OF SHIPPING TRANSACTIONS IN REAL TIME,” each of which are filed concurrently herewith, and the entire contents and substance of all of which are hereby incorporated in total by reference in their entireties and for all purposes.

### TECHNICAL FIELD

The subject matter disclosed herein generally relates to processing data. In some example embodiments, the present disclosures relate to systems and methods for establishing and sharing partnership data in shipping transactions.

### BACKGROUND

In shipping transactions, particularly in a shipping supply chain of the trucking industry, generally, multiple distinct parties may be involved to complete a shipping transaction. The multiple parties are generally categorized as one of a shipper, receiver, broker and carrier. Conventionally, there are many companies that can be categorized into each of these different types of parties, unlike the parcel shipping business where there are only a few major companies (e.g., FedEx, UPS, US Postal Service, etc.). Coordinating the many different types of parties, and the many entities categorized within each party, has typically been conducted manually and without complete information. In addition, it is desirable to be able to differentiate or recognize preferred business relationships throughout the coordination processes. In general, the trucking industry has a long-standing need for improved organization, logistics, and transparency.

### BRIEF SUMMARY

Aspects of the present disclosure are presented for a freight management system configured to allow the generation of partnerships between the various trucking industry parties to be formed, with various functionality and communications enhanced for those partnerships. In some embodiments, a method for improving logistics through the use of these partnerships is presented. The method may include: causing display of one or more freight companies to be considered to enter into a partnership agreement with a first freight company; transmitting, by the freight management system and from a first freight company user interface of the freight management system, a partnership request to a second freight company user interface of a second freight company among the one or more freight companies, wherein: the first freight company is designated a shipping role of any one of a shipper, a carrier, a receiver, or a broker; and the second freight company is designated a shipping role of any one of the shipper, the carrier, the receiver, or the broker that is not the role designated of the first freight company; transmitting, by the freight management system and from the first freight company user interface, first sharing options to the second freight company user interface, the first sharing options limiting an amount of information controlled by the first freight company to be viewable by the second freight company; in response, transmitting acceptances of the partnership request and the first sharing options to the first freight company user interface; transmitting, from the second freight company user interface, second sharing options to the first freight company user interface, the second sharing options limiting an amount of information controlled by the second freight company to be viewable by the first freight company; transmitting, from the first freight company user interface, acceptance of the second sharing options to the second freight company user interface; and transmitting an order request for conducting a shipping transaction to the second freight company user interface that is prioritized in favor of the second freight company over other freight companies among the one or more freight companies that have not accepted a partnership request from the first freight company.

Some embodiments of the method may further include: transmitting, by the freight management system and from the first freight company user interface of the freight management system, a second partnership request to a third freight company user interface of a third freight company among the one or more freight companies, wherein the third freight company is designated a shipping role of any one of the shipper, the carrier, the receiver, or the broker that is not the role designated of the first freight company; transmitting, by the freight management system and from the first freight company user interface, third sharing options to the third freight company user interface, the third sharing options limiting a second amount of information controlled by the first freight company to be viewable by the third freight company; in response, transmitting acceptances of the second partnership request and the third sharing options to the first freight company user interface; transmitting, from the third freight company user interface, fourth sharing options to the first freight company user interface, the fourth sharing options limiting an amount of information controlled by the third freight company to be viewable by the first freight company; and transmitting, from the first freight company user interface, acceptance of the fourth sharing options to the third freight company user interface.

Some embodiments of the method may further include transmitting the order request to the third freight company and prioritizing the order request in favor of the third freight company over the second freight company, based on a specified prioritized partnership hierarchy by the first freight company.

In some embodiments of the method, prioritizing the order request in favor of the third freight company over the second freight company comprises: causing display of the order request in the third freight company user interface while prohibiting display of the order request in the second freight company user interface; and causing display of the order request in the second freight company user interface after a delay in time from causing display of the order request in the third freight company user interface.

In some embodiments of the method, prioritizing the order request in favor of the third freight company over the second freight company comprises: causing display of the order request in the third freight company user interface while prohibiting display of the order request in the second freight company user interface; receiving a rejection notice from the third freight company user to not fulfill the order request; and in response to the rejection, causing display of the order request in the second freight company user interface.

In some embodiments of the method, the sharing options comprise options for: allowing an order request for a shipping transaction to be displayed on specified freight company interfaces; and allowing the order request to be redisplayed on freight company interfaces that are specified partners of the partners of the freight company initiating the order request.

In some embodiments of the method, the sharing options comprise options for: limiting visibility of the order request to freight company partners that are within a specified geographic region; delaying publishing the order request by a specified time period; and specifying a default commission for the order request.

In some embodiments, a freight management system is presented. The system may include a memory; and at least one processor coupled to the memory and configured to: cause display of one or more freight companies to be considered to enter into a partnership agreement with a first freight company; cause display of a first freight company user interface to be interfaced by a first freight company; cause display of a second freight company user interface to be interfaced by a second freight company; transmit, from the first freight company user interface of the freight management system, a partnership request to the second freight company user interface, wherein: the first freight company is designated a shipping role of any one of a shipper, a carrier, a receiver, or a broker; and the second freight company is designated a shipping role of any one of the shipper, the carrier, the receiver, or the broker that is not the role designated of the first freight company; transmit, from the first freight company user interface, first sharing options to the second freight company user interface, the first sharing options limiting an amount of information controlled by the first freight company to be viewable by the second freight company; in response, transmit acceptances of the partnership request and the first sharing options to the first freight company user interface; transmit, from the second freight company user interface, second sharing options to the first freight company user interface, the second sharing options limiting an amount of information controlled by the second freight company to be viewable by the first freight company; transmit, from the first freight company user interface, acceptance of the second sharing options to the second freight company user interface; and transmit an order request for conducting a shipping transaction to the second freight company user interface that is prioritized in favor of the second freight company over other freight companies among the one or more freight companies that have not accepted a partnership request from the first freight company.

In some embodiments, a computer readable medium is presented. The computer readable medium may include instructions that, when executed by a processor, cause the processor to perform operations including: causing display of one or more freight companies to be considered to enter into a partnership agreement with a first freight company; transmitting, by the freight management system and from a first freight company user interface of the freight management system, a partnership request to a second freight company user interface of a second freight company among the one or more freight companies, wherein: the first freight company is designated a shipping role of any one of a shipper, a carrier, a receiver, or a broker; and the second freight company is designated a shipping role of any one of the shipper, the carrier, the receiver, or the broker that is not the role designated of the first freight company; transmitting, by the freight management system and from the first freight company user interface, first sharing options to the second freight company user interface, the first sharing options limiting an amount of information controlled by the first freight company to be viewable by the second freight company; in response, transmitting acceptances of the partnership request and the first sharing options to the first freight company user interface; transmitting, from the second freight company user interface, second sharing options to the first freight company user interface, the second sharing options limiting an amount of information controlled by the second freight company to be viewable by the first freight company; transmitting, from the first freight company user interface, acceptance of the second sharing options to the second freight company user interface; and transmitting an order request for conducting a shipping transaction to the second freight company user interface that is prioritized in favor of the second freight company over other freight companies among the one or more freight companies that have not accepted a partnership request from the first freight company.

### BRIEF DESCRIPTION OF THE DRAWINGS

Some embodiments are illustrated by way of example and not limitation in the figures of the accompanying drawings.

FIG. 1 is a network diagram illustrating an example network environment suitable for aspects of the present disclosure, according to some example embodiments.

FIG. 2 shows an example display of the menu for managing partnerships in a website for facilitating logistics between freight management companies, according to some embodiments.

FIG. 3 shows an example list of companies, including displaying which companies may be preferred partners or not, according to some embodiments.

FIG. 4 provides a display for continuing a process to establish a partnership under a “View Orders” options menu, according to some embodiments.

FIG. 5 shows another display for continuing the process for establishing a partnership under a “Show Orders” options menu, according to some embodiments.

FIG. 6A shows the status change of the requesting party and the receiving party when a partnership request has been made.

FIG. 6B shows the status change of the requesting party or the receiving party when the partnership request has been accepted, from the perspective of the receiving party, according to some embodiments.

FIGS. 7A and 7B show corresponding privileged data between both companies who have formed a partnership, according to some embodiments.

FIG. 8 provides slightly more complex scenario involving a third freight management company also involved as a partner with two other companies, according to some embodiments.

FIG. 9 shows a display menu for allowing whether orders can be shown to a partner and/or propagating partner or not.

FIG. 10 shows an example of the default commissions for automatically dividing up the revenue generated by the shipping transaction, once a partnership order is completed, according to some embodiments.

FIG. 11 shows an example methodology for establishing partnerships within the freight management system of the present disclosures, according to some embodiments.

FIG. 12 is a block diagram illustrating components of a machine, according to some example embodiments, able to read instructions from a machine-readable medium and perform any one or more of the methodologies discussed herein.

### DETAILED DESCRIPTION

Example methods, apparatuses, and systems (e.g., machines) are presented for establishing partnerships and generally providing prioritized and/or preferential treatment to various entities in the shipping supply chain of the trucking industry for shipping transactions. Generally, multiple distinct parties may be involved to complete a shipping transaction, such as a shipment of bottles of wine from a winery to a marketplace, such as a grocery store. The multiple parties are generally categorized as one of a shipper (e.g., the winery), receiver (e.g., the grocery store), broker (e.g., third party middle man helping to coordinate contacts with the parties) and carrier (e.g., truck or trucking company). Conventionally, there are many companies that can be categorized into each of these different types of parties, unlike the parcel shipping business where there are only a few major companies (e.g., FedEx, UPS, US Postal Service, etc.). For example, there are many small trucking businesses, where private contractors simply may offer their resources, e.g., their truck(s), whenever and wherever they may be available. If a shipper prefers a particular trucking service, and the trucking company is not available, the shipper must simply look to another service and hope that next company is available, and so on. Trying to coordinate the schedules and the demands of each of these different types of parties is traditionally extremely cumbersome and susceptible to error. To complicate matters, sometimes preferred partnerships are formed between various shippers, receivers, brokers, and carriers, wherein, for example, a shipper may prefer a particular carrier, while the receiver may prefer a different carrier, while a broker may prefer yet another carrier. These partnerships may also be beneficial in helping to more efficiently communicate logistics. Also, because some freight management companies have designated partnership status and others do not, those that are deemed of lower quality or less reliability can also be downgraded from being a partner. In general, the trucking industry has a long-standing need for improved organization, logistics, and transparency.

Aspects of the present disclosure allow for partnerships between the various trucking industry parties to be formed, with various functionality and communications enhanced for those partnerships. In some embodiments, a freight management website is architected to implement innovative partnership concepts among various freight management companies to realize social network elements tailored for the logistics industry. Freight management companies can configure their preferred business partners so that they can set exactly what and how to share their business target information. Through partnerships, complex logistics business workflow is automated and optimized for trusted freight management companies.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

The following definitions may be used herein.

Freight management system: Main freight management website, including an administrative freight management website, installation phone utility application, freight management software services, freight management tracker hardware and software subsystems.

The freight management system of the present disclosures brings a revolutionary logistics business facilitation and modernization platform that utilizes social network software aspects for intricacy of trucking load processing and cellular communication network with GPS and monitoring sensors for product integrity information.

Freight management company: a company which signed up for the freight management website. The freight management company may have one or more roles typical in the trucking industry, described more below.

Freight management user: a user under a signed-up freight management company. The freight management company can have multiple users.

Freight management company roles follow the business entities in the trucking supply chain/logistics, which are Shipper, Receiver, Broker and Carrier. A shipper generally is defined as an entity that has goods to be moved to a receiver, such as a manufacturer of goods. A receiver generally is defined as an entity that is designated to receive goods from a shipper, such as a retail store or grocery store. A carrier generally is defined as an entity designated to pick up a shipment of goods and transport said goods to a designated location. The carrier generally is in control of shipping assets, like one or more trucks (e.g., 18 wheelers). A carrier may be a single individual who owns a truck and uses his truck to pick up and transport goods, or may be a larger organization that controls a fleet of trucks and drivers. While some companies have integrated solutions and include carrier functionality for its shipping or receiving operations, it is often the case that the shipper, carrier, and receiver are distinct and separate entities. A broker generally is defined as a coordinator to facilitate the completion of the shipping supply chain between the shipper, carrier, and receiver. A broker may be responsible for contacting various carriers to fulfill shipping and receiving needs, for example.

Freight management company can identify itself and utilize the freight management system as one or multiples of business roles where the freight management website provides unprecedented visibility to the freight management companies.

Partnership: freight management companies can establish partnerships amongst themselves to benefit each other in the business practice to facilitate their own operations.

Contact: There are three types of contacts—public (from e.g., FMCSA database), private (e.g., Freight management company maintained from public contacts) and my company public (e.g., company's public list compilation if it has multiple locations).

Asset: A freight management tracker attached trailer or tractor of the truck.

Order: A freight management order is a work order or shipping/delivery load which encompasses all the necessary information to move goods from A to B including pickups, deliveries, carrier, tracking, requirement, sharing, equipment, driver, finance information, product integrity information such as temperature, speed and more.

Order may have a number of different statuses, expressed in codes. Order has eight status including AVL (available), BKD (booked), DIS (dispatched), LDG (loading), LDD (loaded), ULD (unloading), MT (empty) and STL (settled). Other statuses readily apparent to those with ordinary skill in the art are also possible, and embodiments are not so limited.

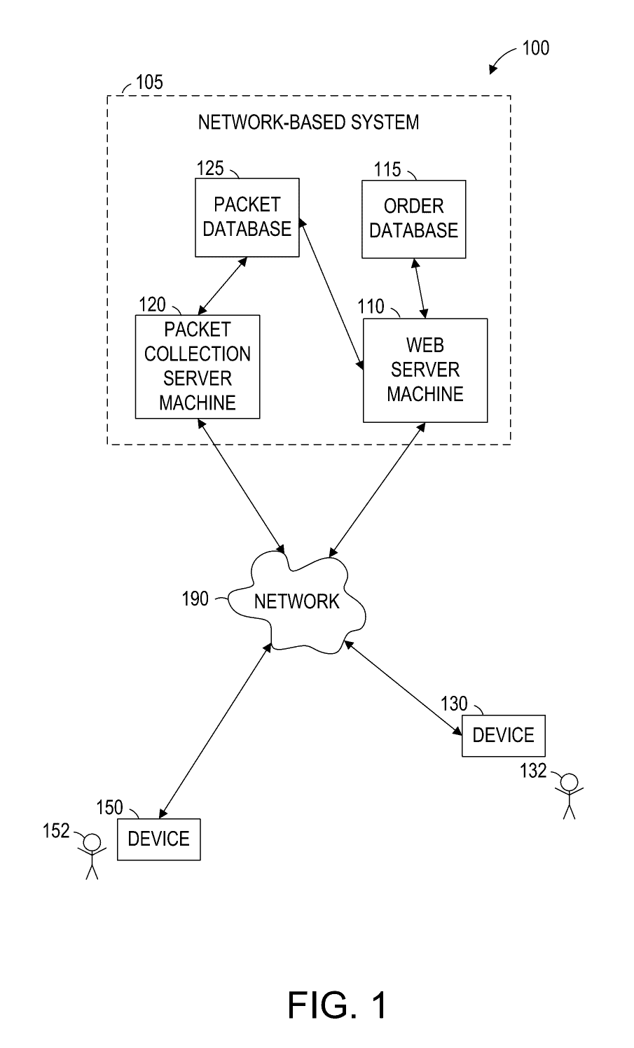

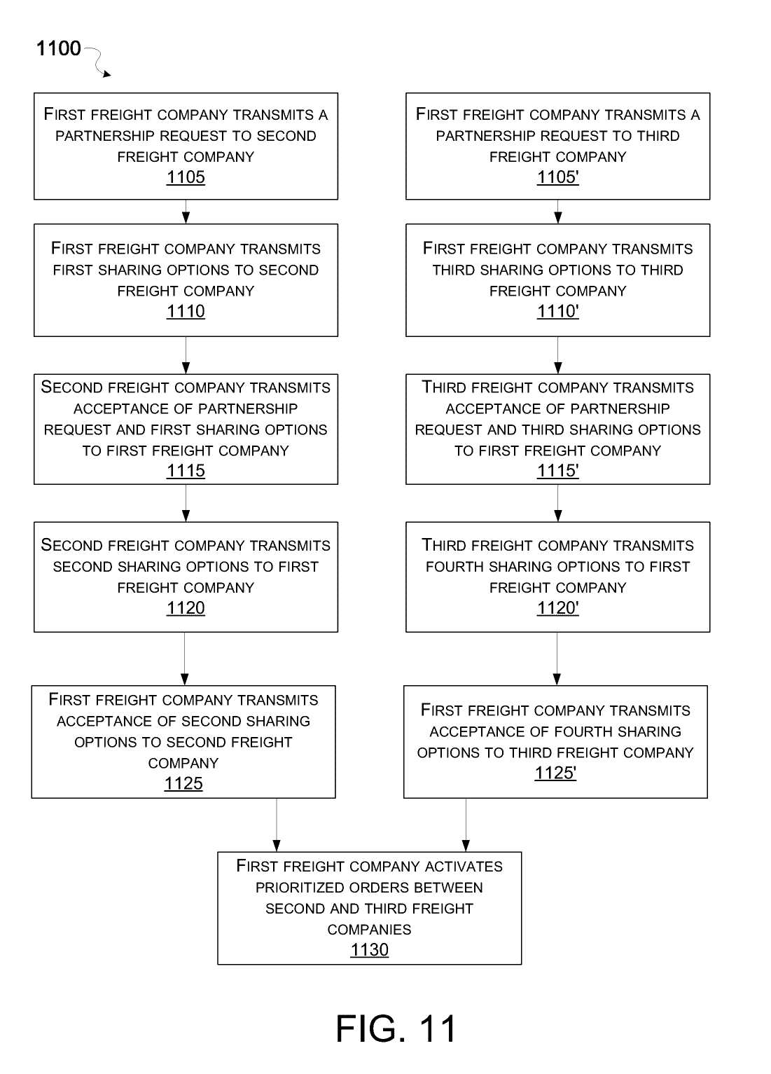

Referring to FIG. 1, a network diagram illustrating an example network environment 100 suitable for performing aspects of the present disclosure is shown, according to some example embodiments. The example network environment 100 includes a web server machine 110, an order database 115, a packet collection server machine 120, a packet database 125, a first device 130 for a first user 132, and a second device 150 for a second user 152, wherein the server machines 110 and 120 are communicatively coupled to the devices 130 and 150 via a network 190. In some embodiments, either or both of the web server machine 110 and packet collection server machine 120 may form all or part of a network-based system 105 (e.g., a cloud-based server system configured to provide one or more services to the first and second devices 130 and 150). The web server machine 110, the packet collection server machine 120, the first device 130, and the second device 150 may each be implemented in a computer system, in whole or in part, as described below with respect to FIG. 11. Through this example configuration of the network-based system 105, aspects of the present disclosure may be configured to enable either of the devices 130 or 150 to track information derived from the other device 150 or 130, as well as track any web interface devices, such as if device 130 or 150 operates as a web interface device. In other words, the devices 130 and 150 may be configured to interface with the system of the present disclosures, as well as with other devices, through both a web-based interface and through an app-based interface.

Also shown in FIG. 1 are the first user 132 and the second user 152. One or both of the first and second users 132 and 152 may be a human user, a machine user (e.g., a computer configured by a software program to interact with the first device 130), or any suitable combination thereof (e.g., a human assisted by a machine or a machine supervised by a human). The first user 132 may be associated with the first device 130 and may be a user of the first device 130. For example, the first device 130 may be a desktop computer, a vehicle computer, a tablet computer, a navigational device, a location tracking device, a monitoring sensor data collecting device, a portable media device, a smartphone, or a wearable device (e.g., a smart watch or smart glasses) belonging to the first user 132. Likewise, the second user 152 may be associated with the second device 150. As an example, the second device 150 may be a desktop computer, a vehicle computer, a tablet computer, a navigational device, a location tracking device, a monitoring sensor data collecting device, a portable media device, a smartphone, or a wearable device (e.g., a smart watch or smart glasses) belonging to the second user 152. Other devices, not shown, may also be configured to interface with the network-based server 105 similar to devices 130 and 150, and embodiments are not so limited. For example, the first device 130 may be operated by a shipper, the second device 150 may be operated by a carrier, a third device may be operated by a broker, and a fourth device may be operated by a receiver, all of which may be configured to transmit and receive information about a shipping transaction from each other device.

Any of the machines 110 and 120, databases 115 and 125, or first or second devices 130 or 150 shown in FIG. 1 may be implemented in a general-purpose computer modified (e.g., configured or programmed) by software (e.g., one or more software modules) to be a special-purpose computer to perform one or more of the functions described herein for that machine 110 or 120, database 115 or 125, or first or second device 130 or 150. For example, a computer system able to implement any one or more of the methodologies described herein is discussed below with respect to any of the descriptions in the following figures. As used herein, a “database” may refer to a data storage resource and may store data structured as a text file, a table, a spreadsheet, a relational database (e.g., an object-relational database), a triple store, a hierarchical data store, any other suitable means for organizing and storing data or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines 110 and 120, databases 115 and 125, and devices 130 and 150. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include, for example, one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 190 may communicate information via a transmission medium. As used herein, “transmission medium” may refer to any intangible (e.g., transitory) medium that is capable of communicating (e.g., transmitting) instructions for execution by a machine (e.g., by one or more processors of such a machine), and can include digital or analog communication signals or other intangible media to facilitate communication of such software.

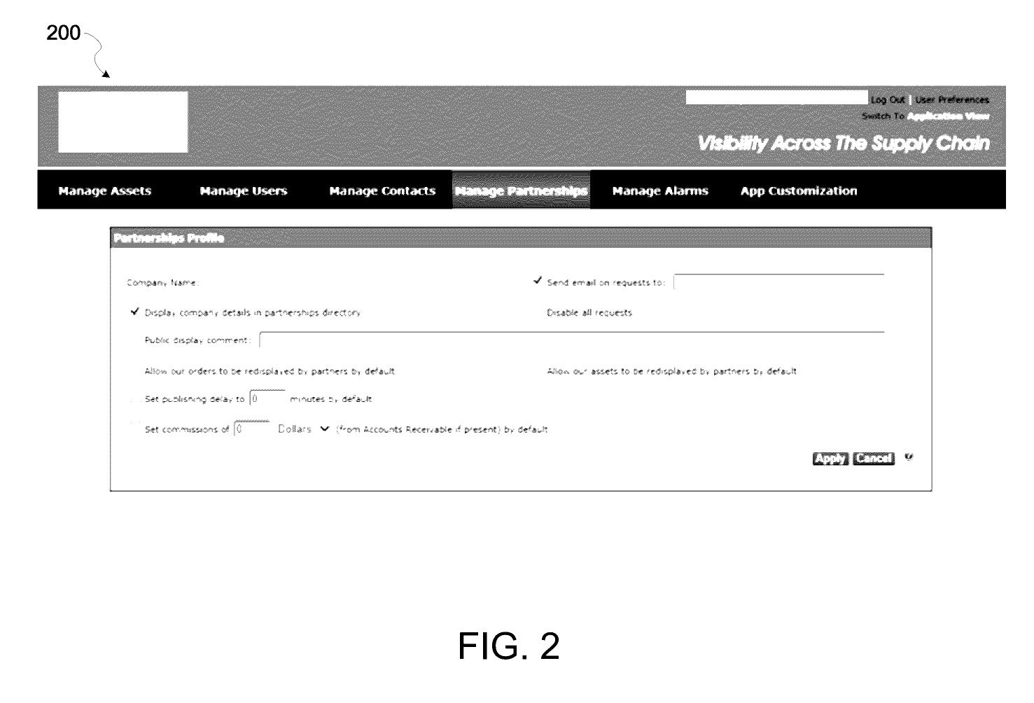

Referring to FIG. 2, illustration 200 shows an example display of the menu for managing partnerships in a website for facilitating logistics between freight management companies, according to some embodiments. For example, from an Administration View, a company administrator can set a default partnership profile via “My Profile” settings from the “Manage Partnerships” submenu, as shown. The freight management company can advertise its presence and universal sharing options, as illustrated by checking the box marked “display company details and partnerships directory,” as one example. Here, a default set of options is selected that may apply to all partnership companies in general. However, additional options may be possible, including controlling when the freight management company may wish to display its orders in the partner's order console. These may be set in the individual partnership settings. Being able to control the timing of the freight management companies order publications can allow for strategic ordering or providing preferential treatment by coordinating times with other companies. In general, the partnership options described herein allow for strategic prioritization of certain companies over others for fulfillment of orders based at least in part on timing of when orders and shipping contracts are to be posted to various community displays within the website, according to some embodiments.

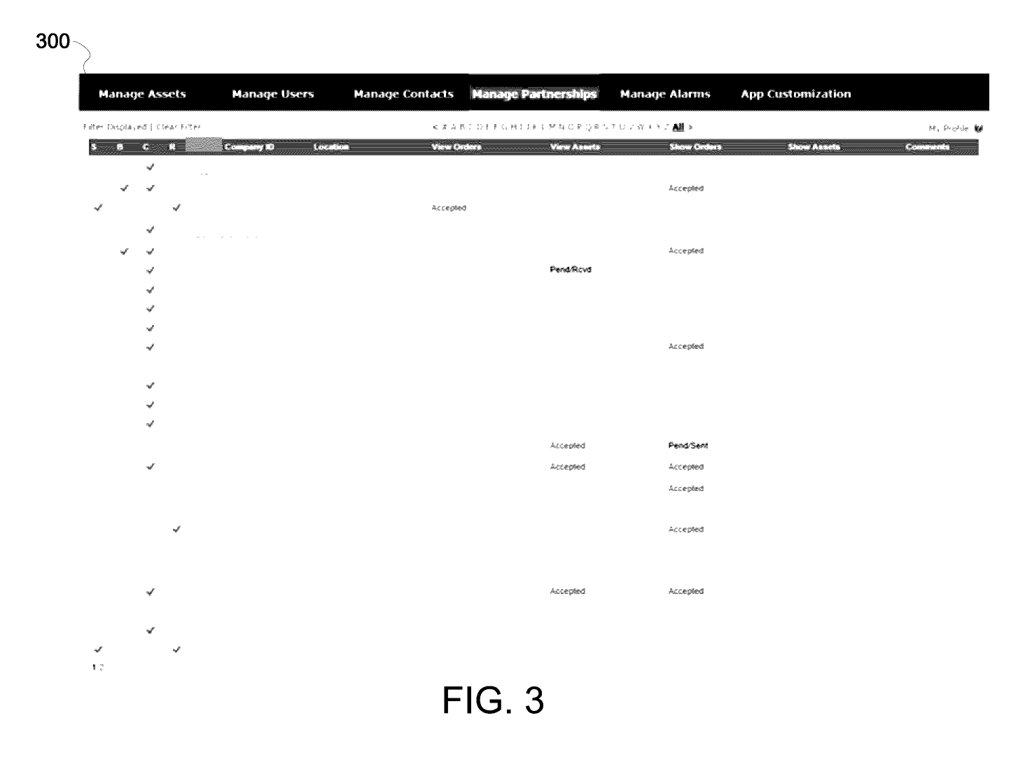

Referring to FIG. 3, illustration 300 shows an example list of companies, including displaying which companies may be preferred partners or not, according to some embodiments. The names of the companies are redacted herein for security purposes. In some embodiments, while universal sharing options can be set via a “My Profile” page within the website, individual partnership properties with various freight management companies can be set to maximize controllability. The “Manage Partnerships” menu view shows the summary grid listing current partnership status. Partnership sharing is two directional, as “View Orders” and “View Assets” are to view other partners' data while “Show Orders” and “Show Assets” are to allow for other partners to view the data. The summary grid shows two stages of partnership establishment, such as “Pending/Received” or “Pending/Sent” based on direction, representing requested stage, and “Accepted,” representing mutual agreement stage, for respective sharing options. Note that the red colored freight management company ID represents an unverified state of the company, which can be cleared/moderated via a separate freight management Admin site, according to some embodiments.

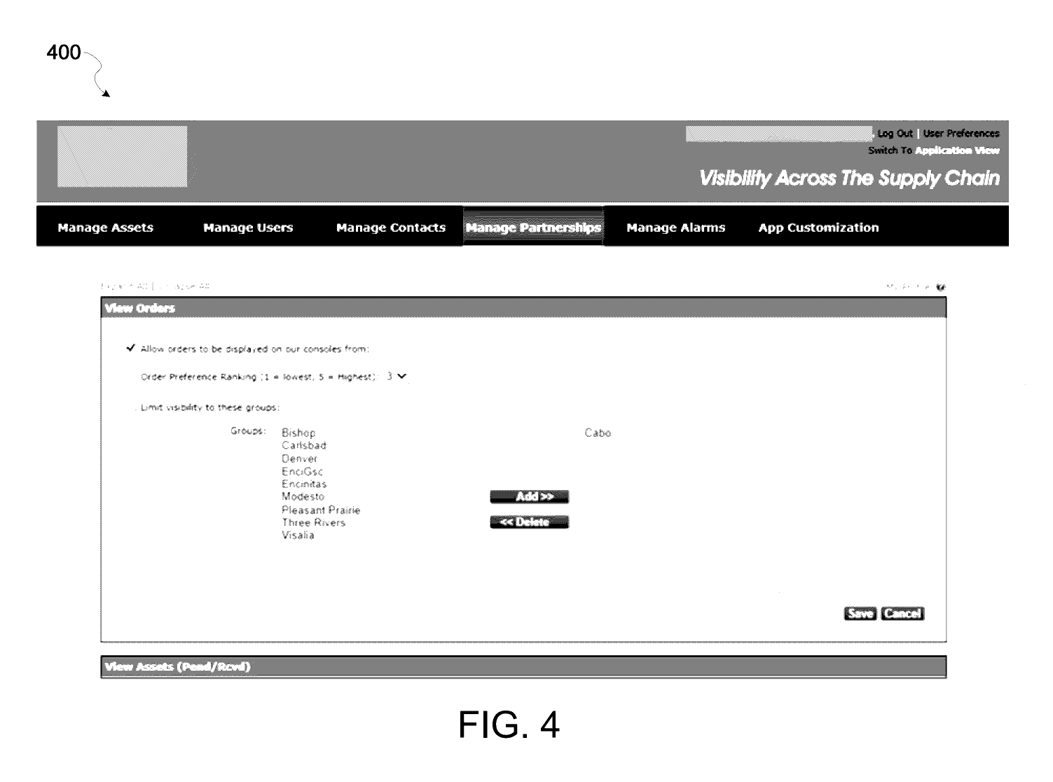

Referring to FIG. 4, illustration 400 provides a first display for continuing a process to establish a partnership, according to some embodiments. A typical partnership establishment sequence is as follows:

First, the user picks a desirable freight management company to partner with from an available list, in some cases by selecting an ID link. In other cases, the user may select a company by clicking on their company name. An example list may be like one shown in FIG. 3. In a second step, the user decides which sharing option(s) (out of “View Orders,” “View Assets,” “Show Orders,” and “Show Assets,” according to some embodiments) to establish with the target company. In FIG. 4, the sharing options under “View Orders” is shown.

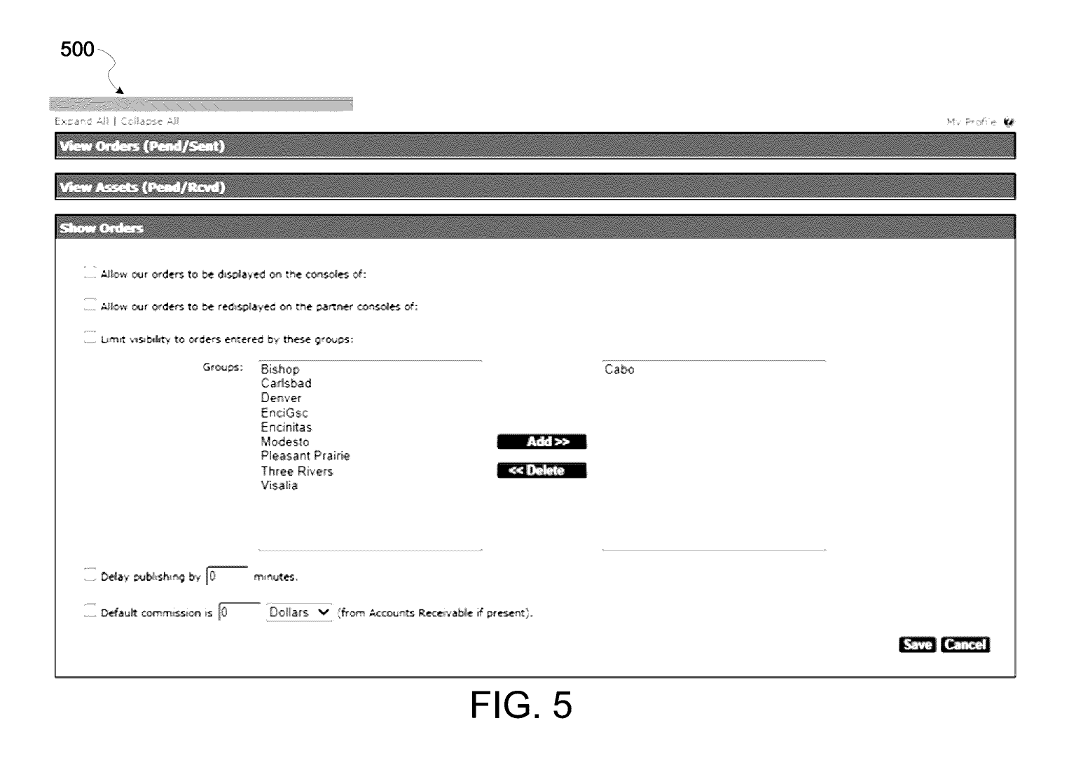

Referring to FIG. 5, illustration 500 shows a continuation of the second step for establishing a partnership, according to some embodiments. Here, the options under the “Show Orders” menu are shown. The user can control a number of options, including a preference rating (see also FIG. 4), visibility inclusion of the user company's inner groups, sharing propagation to the partners of a selected partner, publishing delay, automatic percentage or dollar amount for commission, etc.

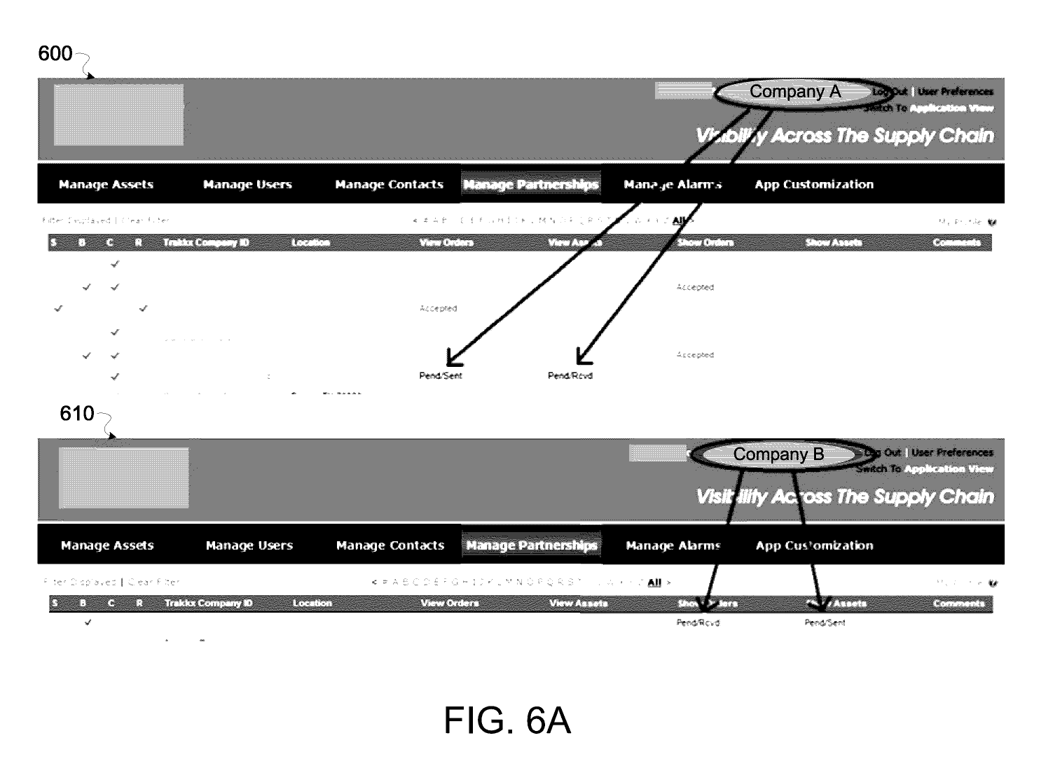

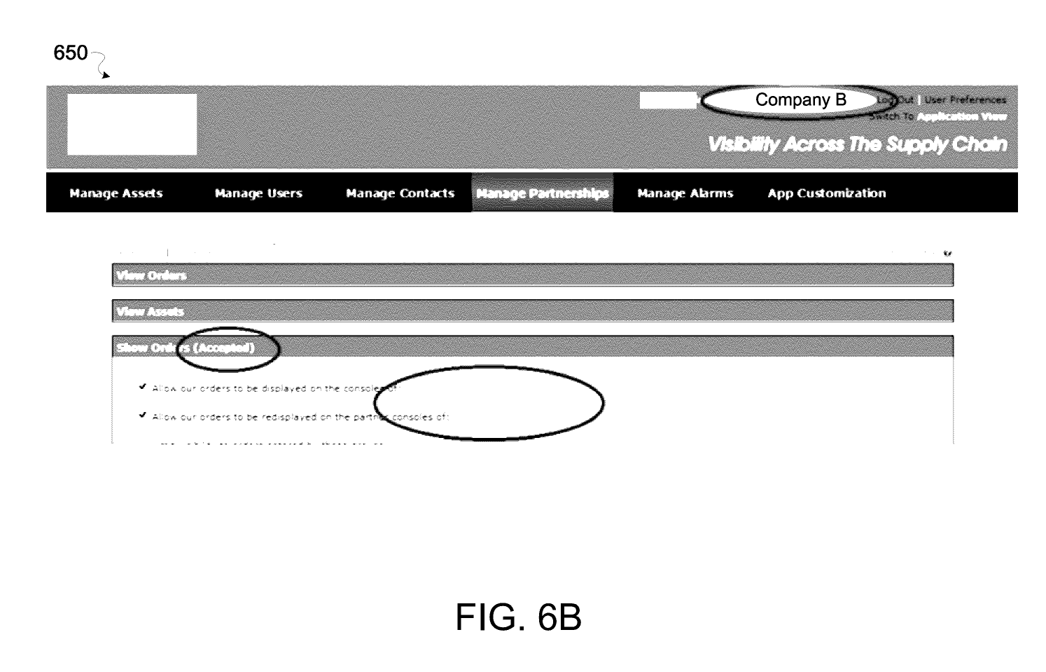

Referring to FIG. 6A, illustrations 600 and 610 show the status change for a partnership request. Saving each respective sharing option becomes a partnership request for the target partner. The partnership summary grid shows as “Pend/Sent” or “Pend/Rcvd” based on who initiates the action. For example, if freight management company A wants to view orders of freight management company B, while freight management company B wants to show assets to freight management company A, each sends a request by saving “View Orders” or “Show Assets” option, respectively. Then, the partnership summary grid would show “Pend/Sent” for “View Orders” and “Pend/Rcvd” for “View Assets” for freight management company A, as shown in illustration 600, while it would show “Pend/Rcvd” for “Show Orders” and “Pend/Sent” for “Show Assets” for freight management company B, as shown in illustration 610.

Referring to FIG. 6B, in illustration 650, third, the user from the freight management company that received the request(s) accepts sharing options(s) by saving in a corresponding option. FIG. 6B shows the change from the receiving party side. The partnership configuration and the above summary grid would, then, become “Accepted.” Now a sharing partnership for this mutually agreed option is established.

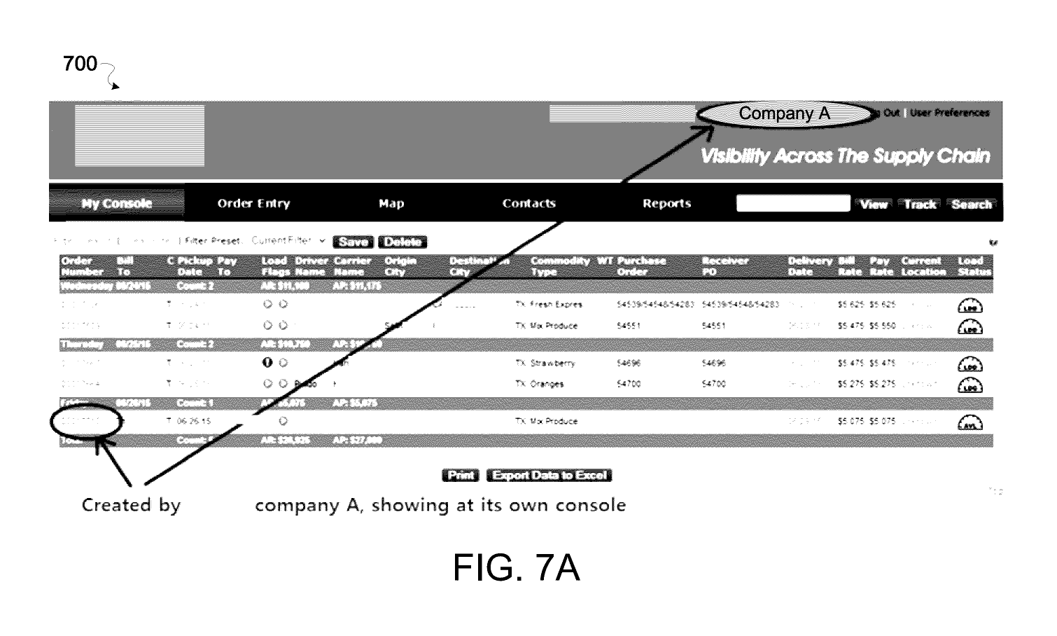

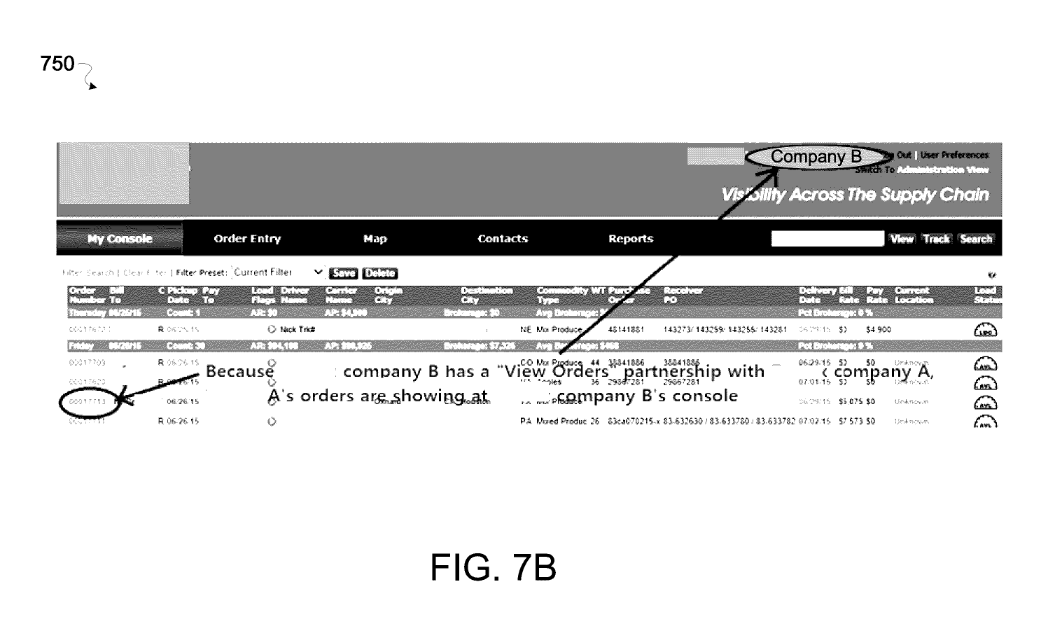

Referring to FIGS. 7A and 7B, corresponding privileged data is now shown between both companies who have formed a partnership, shown in illustrations 700 and 750. That is, once a partnership for a selected sharing option is established between two freight management companies, the target data would propagate in the direction defined in the partnership settings (see for example, the options in FIG. 5). If freight management company A is agreed to show its orders to freight management company B, freight management company B can view this order on its order console after configured delay, if any.

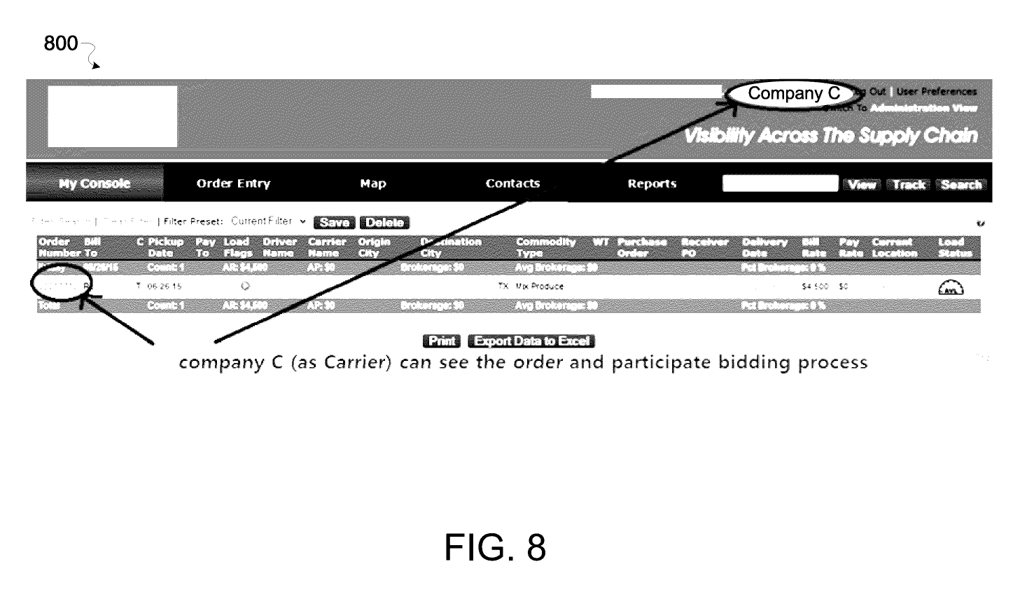

From the above example, FIG. 8 provides an example to illustrate partnership dynamics further in the logistics business. Suppose freight management company A is a Shipper and freight management company B is a Broker without its own trucks but with many Carrier partners. Now assume freight management company B (Broker) has established “Show Orders” partnerships with these Carrier partners but does not specify one as the carrier for a particular order, then, based on the individual partnership settings, such as publishing delay and commission structure, the order will appear on these freight management companies of possible Carriers with an associated target cost. Note that order-level sharing can also be configured by the Order Entry's Load Sharing section for additional fine-grained inclusion control, and the target price can be simply declared through the “Pay To” section by the Broker instead of automatic commission deduction, too. Some (or all) carriers may bid for their business by assigning themselves as the Carrier via the freight management Order Entry page. Preference rating and timing may factor in when awarding one carrier automatically. In this example, the finance chain (singular path of Shipper-Broker-Carrier) is completed for this order. Once completed, other carrier candidates cannot access this order anymore.

Another partnership example for a more complex scenario can be:

Shipper A has partnerships with Brokers A, B, C and Carriers A, B

Shipper A creates an order, and through individual partnership configurations, this order appears on Broker A, B's consoles immediately, and Broker C, Carrier A, B's consoles after 20 minutes (if Broker A or B does not take it). In general, partnerships allow for customization of timing and communication, even between different partnerships. Therefore, multiple tiers of communications may be possible even within established partnerships, as well as differentiating communications from all other companies not in partnership.

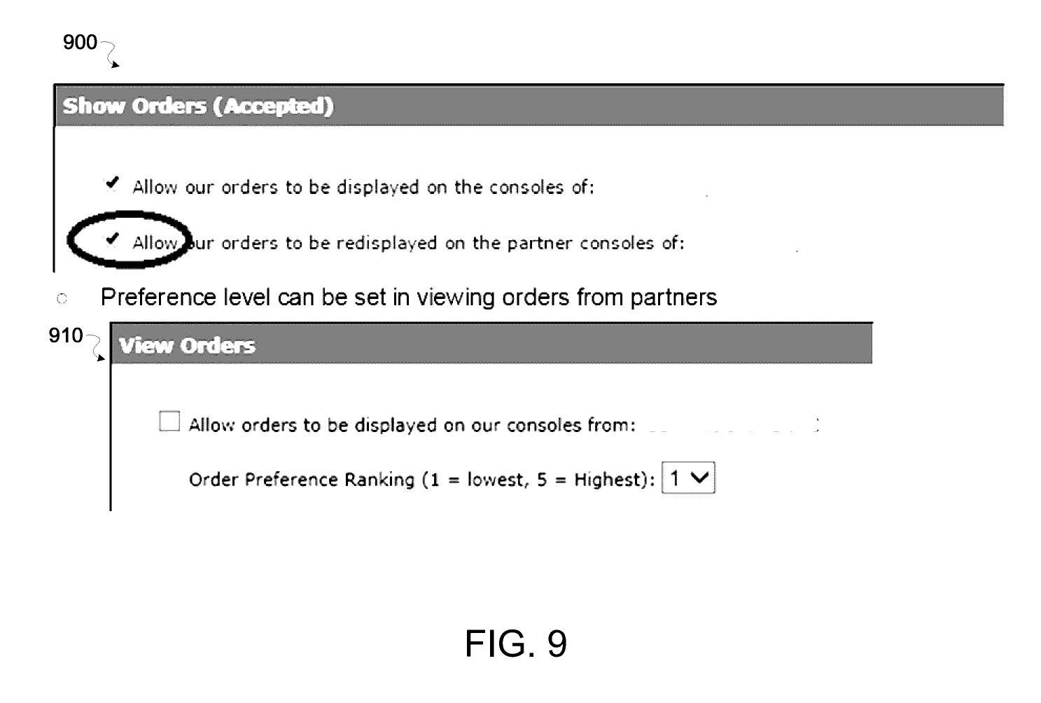

More propagation can be possible through enabling a re-sharing option. FIG. 9 in illustration 900 provides an example of this re-sharing option.

Once an order is booked by any order of viewing partners, the finance chain of the order is completed. It can be one of Shipper-Broker-Carrier or Shipper-Carrier, or Shipper-Broker paths, for example, and commission structures (dollar amount or percentage) between partners are automatically applied. Once booked, only active participators can access the order and the system prevents other partners from viewing the order immediately.

Still referring to FIG. 9, illustration 910 shows a display menu for setting a preference level for prioritizing what partners may be allowed to see the company's orders.

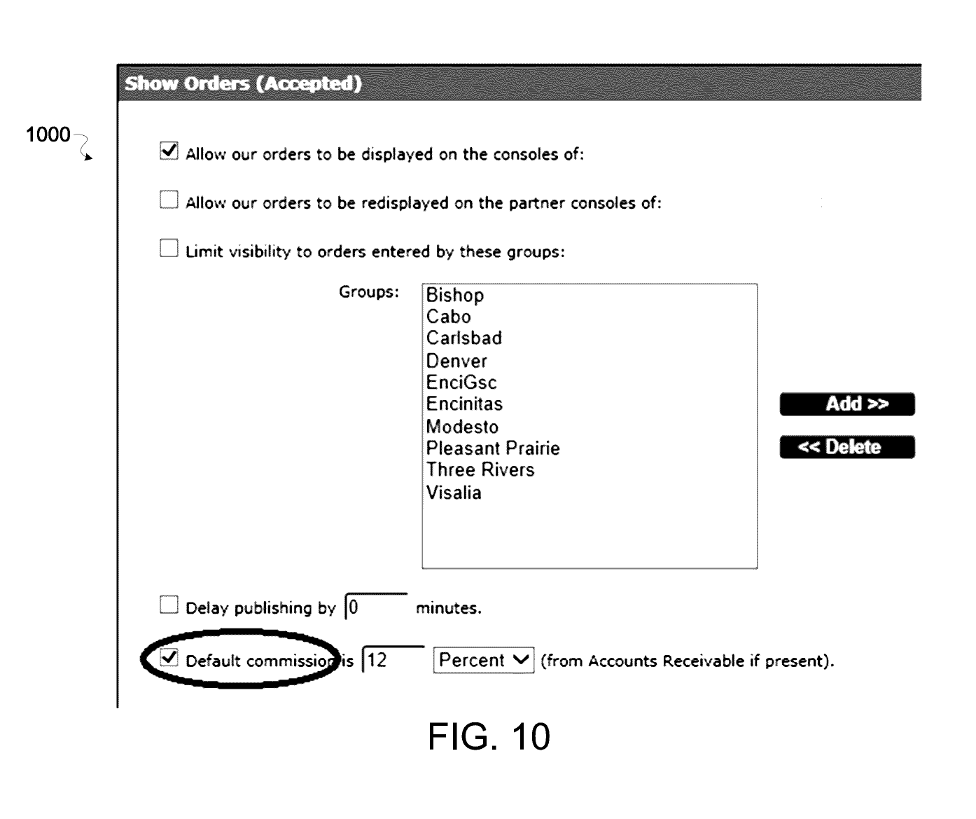

FIG. 10 in illustration 1000 shows an example of the default commissions for automatically dividing up the revenue generated by the shipping transaction, once a partnership order is completed, according to some embodiments. Many other complex partnership scenarios can be formulated, generating as many dependency situations for locking/unlocking order modification. The freight management website can accommodate any of those arising challenging cases as it is an expert system based on business heuristics.

Referring to FIG. 11, flowchart 1100 shows an example methodology for establishing partnerships within the freight management system of the present disclosures, according to some embodiments. In this example, a first freight company may establish partnerships with multiple other freight companies, and then may be able to prioritize or give preferential access to orders even among the established partnerships. As shown, two independent communications may occur, leading to a combined step integrating the actions in the independent communications. In this illustration, the term “freight company” may be in reference to any or all users of the freight company who interface with the freight management system of the present disclosures, e.g., a freight company user.

At block 1105, the first freight company may transmit a partnership request to a second freight company. The methods for performing such an action may be consistent with the example interfaces described above. The freight management system may be configured to facilitate the actions of flowchart 1100, and may be implemented by the network-based system 105, for example. The first freight company may take on any of the four described roles in the trucking industry as described herein. Concurrently, or at least independently and not in any particular order, at block 1105′ the first freight company may transmit another partnership request to a third freight company. The second and third freight companies may take on any of the other three roles that the first freight company is not. In some cases, though with less practical value, the first freight company may form a partnership with another company having the same role.

At block 1110, the first freight company may transmit first sharing options to the second freight company. Examples of sharing options are described in the previous figures, such as in FIGS. 2, 3, and 4. Thus, establishing a partnership carries with it certain but varied privileges, as desired by the requester. Concurrently, or at least independently, at block 1110′, the first freight company may do the same for the third freight company and transmit third sharing options to the third freight company. The sharing options may be different between the two companies, and embodiments are not so limited. The network-based system 105 may facilitate the transmission and enable the functionality described herein.

At block 1115, the second freight company may then receive the requests and correspondingly accept the partnership and sharing options. This is transmitted to the first freight company. The second freight company is entitled to not accept, not shown. On the other side, at block 1115′, the third freight company may similarly receive and the requests and correspondingly accept the partnership and sharing options.

At block 1120, the second freight company also may transmit its own second sharing options to the first freight company. The sharing options may or may not be the same options provided by the first freight company, as the needs and preferences between the companies may differ. Thus, the freight management system of the present disclosures allows for asymmetric levels of sharing data even between partners. Similarly, at block 1120′, the third freight company may transmit its own fourth sharing options to the first freight company. Again, these options may not be the same as the ones offered by the first freight company to the third freight company.

At block 1125, the first freight company may then receive and accept the second sharing options of the second freight company, and may then transmit such acceptance to the second freight company. Similarly, at block 1125′, the first freight company may also receive and accept the fourth sharing options of the third freight company, and may then transmit such acceptance to the third freight company. In general, notice that all sets of sharing options may be entirely different from one another, even though two sets of partnerships are formed.

In addition, the acceptance of these partnerships and sharing options creates new displayed information available to each of the freight companies, consistent with the example displays described above. Furthermore, after the partnerships are formed, additional options may be tweaked, revised or changed, consistent with the many options described in the example displays throughout the present disclosures.

At block 1130, having now established two distinct partnerships, the first freight company may activate or initiate a prioritized or preferential order between the second and third freight companies. This prioritized order may allow the either the second or third company to have better access to the same order entry over the other company, due to having formed the partnerships. The freight management system, as implemented in the network-based system 105, for example, may be configured to transmit the order entry to a prioritized partner first, and then after a specified delay or other threshold condition, may be configured to transmit the same order to a partner at a lower prioritized level. In addition, while not shown, the prioritized or preferential order functionality may also be applied against other companies not engaged in a partnership with the first freight company. For example, if the second freight company is given prioritized treatment over the third company, but second freight company does not accept an order entry offered by the first freight company, and then the third freight company also does not accept the order entry later, the order entry may then be displayed more publically to all companies not engaged in a partnership with the first freight company. In other cases, through additional partnerships with the second or third companies, the order entry may be passed to other “2nd degree” partnerships. The order entry and/or sharing options by the first freight company may specify allowing for the order to be passed on through these channels or not. In some embodiments, many levels of prioritization (e.g., five levels) may be possible, although only two are described in this example.

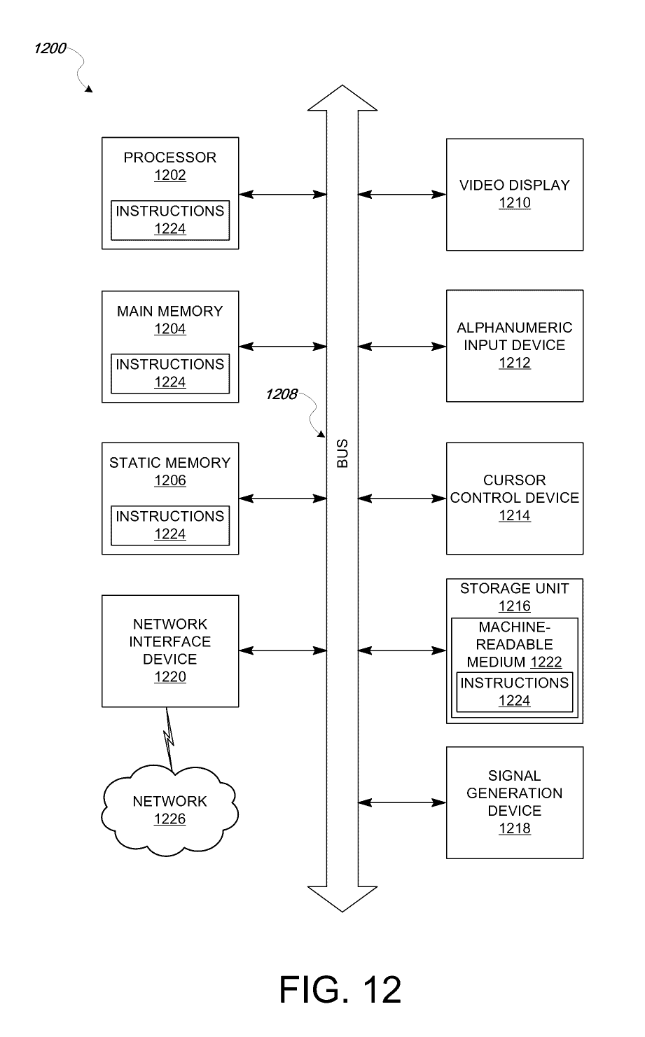

Referring to FIG. 12, the block diagram illustrates components of a machine 1200, according to some example embodiments, able to read instructions 1224 from a machine-readable medium 1222 (e.g., a non-transitory machine-readable medium, a machine-readable storage medium, a computer-readable storage medium, or any suitable combination thereof) and perform any one or more of the methodologies discussed herein, in whole or in part. Specifically, FIG. 12 shows the machine 1200 in the example form of a computer system (e.g., a computer) within which the instructions 1224 (e.g., software, a program, an application, an applet, an app, or other executable code) for causing the machine 1200 to perform any one or more of the methodologies discussed herein may be executed, in whole or in part.

In alternative embodiments, the machine 1200 operates as a standalone device or may be connected (e.g., networked) to other machines. In a networked deployment, the machine 1200 may operate in the capacity of a server machine 120 or a client machine in a server-client network environment, or as a peer machine in a distributed (e.g., peer-to-peer) network environment. The machine 1200 may include hardware, software, or combinations thereof, and may, as example, be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1224, sequentially or otherwise, that specify actions to be taken by that machine. Further, while only a single machine 1200 is illustrated, the term “machine” shall also be taken to include any collection of machines that individually or jointly execute the instructions 1224 to perform all or part of any one or more of the methodologies discussed herein.

The machine 1200 includes a processor 1202 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1204, and a static memory 1206, which are configured to communicate with each other via a bus 1208. The processor 1202 may contain microcircuits that are configurable, temporarily or permanently, by some or all of the instructions 1224 such that the processor 1202 is configurable to perform any one or more of the methodologies described herein, in whole or in part. For example, a set of one or more microcircuits of the processor 1202 may be configurable to execute one or more modules (e.g., software modules) described herein.

The machine 1200 may further include a video display 1210 (e.g., a plasma display panel (PDP), a light emitting diode (LED) display, a liquid crystal display (LCD), a projector, a cathode ray tube (CRT), or any other display capable of displaying graphics or video). The machine 1200 may also include an alphanumeric input device 1212 (e.g., a keyboard or keypad), a cursor control device 1214 (e.g., a mouse, a touchpad, a trackball, a joystick, a motion sensor, an eye tracking device, or other pointing instrument), a storage unit 1216, a signal generation device 1218 (e.g., a sound card, an amplifier, a speaker, a headphone jack, or any suitable combination thereof), and a network interface device 1220.

The storage unit 1216 includes the machine-readable medium 1222 (e.g., a tangible and non-transitory machine-readable storage medium) on which are stored the instructions 1224 embodying any one or more of the methodologies or functions described herein, including, for example, any of the descriptions of FIGS. 1-11. The instructions 1224 may also reside, completely or at least partially, within the main memory 1204, within the processor 1202 (e.g., within the processor's cache memory), or both, before or during execution thereof by the machine 1200. The instructions 1224 may also reside in the static memory 1206.

Accordingly, the main memory 1204 and the processor 1202 may be considered machine-readable media 1222 (e.g., tangible and non-transitory machine-readable media). The instructions 1224 may be transmitted or received over a network 1226 via the network interface device 1220. For example, the network interface device 1220 may communicate the instructions 1224 using any one or more transfer protocols (e.g., HTTP). The machine 1200 may also represent example means for performing any of the functions described herein, including the processes described in FIGS. 1-11.

In some example embodiments, the machine 1200 may be a portable computing device, such as a smart phone or tablet computer, and have one or more additional input components (e.g., sensors or gauges) (not shown). Examples of such input components include an image input component (e.g., one or more cameras), an audio input component (e.g., a microphone), a direction input component (e.g., a compass), a location input component (e.g., a GPS receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium 1222 able to store data temporarily or permanently and may be taken to include, but not be limited to, random-access memory (RAM), read-only memory (ROM), buffer memory, flash memory, and cache memory. While the machine-readable medium 1222 is shown in an example embodiment to be a single medium, the term “machine-readable medium” should be taken to include a single medium or multiple media (e.g., a centralized or distributed database 125, or associated caches and servers) able to store instructions 1224. The term “machine-readable medium” shall also be taken to include any medium, or combination of multiple media, that is capable of storing the instructions 1224 for execution by the machine 1200, such that the instructions 1224, when executed by one or more processors of the machine 1200 (e.g., processor 1202), cause the machine 1200 to perform any one or more of the methodologies described herein, in whole or in part. Accordingly, a “machine-readable medium” refers to a single storage apparatus or device 130 or 150, as well as cloud-based storage systems or storage networks that include multiple storage apparatus or devices 130 or 150. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Furthermore, the machine-readable medium 1222 is non-transitory in that it does not embody a propagating signal. However, labeling the tangible machine-readable medium 1222 as “non-transitory” should not be construed to mean that the medium is incapable of movement; the medium should be considered as being transportable from one physical location to another. Additionally, since the machine-readable medium 1222 is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium 1222 or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 1202 or a group of processors 1202) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 1202 or other programmable processor 1202. It will be appreciated that the decision to implement a hardware module mechanically, in dedicated and permanently configured circuitry, or in temporarily configured circuitry (e.g., configured by software) may be driven by cost and time considerations.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses 1208) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 1202 that are temporarily configured (e.g., by software) or permanently configured to perform the relevant operations. Whether temporarily or permanently configured, such processors 1202 may constitute processor-implemented modules that operate to perform one or more operations or functions described herein. As used herein, “processor-implemented module” refers to a hardware module implemented using one or more processors 1202.

Similarly, the methods described herein may be at least partially processor-implemented, a processor 1202 being an example of hardware. For example, at least some of the operations of a method may be performed by one or more processors 1202 or processor-implemented modules. As used herein, “processor-implemented module” refers to a hardware module in which the hardware includes one or more processors 1202. Moreover, the one or more processors 1202 may also operate to support performance of the relevant operations in a “cloud computing” environment or as a “software as a service” (SaaS). For example, at least some of the operations may be performed by a group of computers (as examples of machines 1200 including processors 1202), with these operations being accessible via a network 1226 (e.g., the Internet) and via one or more appropriate interfaces (e.g., an API).

The performance of certain operations may be distributed among the one or more processors 1202, not only residing within a single machine 1200, but deployed across a number of machines 1200. In some example embodiments, the one or more processors 1202 or processor-implemented modules may be located in a single geographic location (e.g., within a home environment, an office environment, or a server farm). In other example embodiments, the one or more processors 1202 or processor-implemented modules may be distributed across number of geographic locations.

Unless specifically stated otherwise, discussions herein using words such as “processing,” “computing,” “calculating,” “determining,” “presenting,” “displaying,” or the like may refer to actions or processes of a machine 1200 (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

The present disclosure is illustrative and not limiting. Further modifications will be apparent to one skilled in the art in light of this disclosure and are intended to fall within the scope of the appended claims.

What is claimed is:

1. A method for improving shipping transactions through a freight management system, the method comprising:
causing display of one or more freight companies to be considered to enter into a partnership agreement with a first freight company;
transmitting, by the freight management system and from a first freight company user interface of the freight management system, a partnership request to a second freight company user interface of a second freight company among the one or more freight companies, wherein:
the first freight company is designated a shipping role of any one of a shipper, a carrier, a receiver, or a broker; and
the second freight company is designated a shipping role of any one of the shipper, the carrier, the receiver, or the broker that is not the role designated of the first freight company;
transmitting, by the freight management system and from the first freight company user interface, first sharing options to the second freight company user interface, the first sharing options limiting an amount of information controlled by the first freight company to be viewable by the second freight company;
in response, transmitting acceptances of the partnership request and the first sharing options to the first freight company user interface;
transmitting, from the second freight company user interface, second sharing options to the first freight company user interface, the second sharing options limiting an amount of information controlled by the second freight company to be viewable by the first freight company;
transmitting, from the first freight company user interface, acceptance of the second sharing options to the second freight company user interface; and
transmitting an order request for conducting a shipping transaction to the second freight company user interface that is prioritized in favor of the second freight company over other freight companies among the one or more freight companies that have not accepted a partnership request from the first freight company.

2. The method of claim 1, further comprising:
transmitting, by the freight management system and from the first freight company user interface of the freight management system, a second partnership request to a third freight company user interface of a third freight company among the one or more freight companies, wherein the third freight company is designated a shipping role of any one of the shipper, the carrier, the receiver, or the broker that is not the role designated of the first freight company;
transmitting, by the freight management system and from the first freight company user interface, third sharing options to the third freight company user interface, the third sharing options limiting a second amount of information controlled by the first freight company to be viewable by the third freight company;
in response, transmitting acceptances of the second partnership request and the third sharing options to the first freight company user interface;
transmitting, from the third freight company user interface, fourth sharing options to the first freight company user interface, the fourth sharing options limiting an amount of information controlled by the third freight company to be viewable by the first freight company; and
transmitting, from the first freight company user interface, acceptance of the fourth sharing options to the third freight company user interface.

3. The method of claim 2, further comprising transmitting the order request to the third freight company and prioritizing the order request in favor of the third freight company over the second freight company, based on a specified prioritized partnership hierarchy by the first freight company.

4. The method of claim 3, wherein prioritizing the order request in favor of the third freight company over the second freight company comprises:
causing display of the order request in the third freight company user interface while prohibiting display of the order request in the second freight company user interface; and
causing display of the order request in the second freight company user interface after a delay in time from causing display of the order request in the third freight company user interface.

5. The method of claim 3, wherein prioritizing the order request in favor of the third freight company over the second freight company comprises:
causing display of the order request in the third freight company user interface while prohibiting display of the order request in the second freight company user interface;
receiving a rejection notice from the third freight company user to not fulfill the order request; and
in response to the rejection, causing display of the order request in the second freight company user interface.

6. The method of claim 1, wherein the sharing options comprise options for:
allowing an order request for a shipping transaction to be displayed on specified freight company interfaces; and
allowing the order request to be redisplayed on freight company interfaces that are specified partners of the partners of the freight company initiating the order request.

7. The method of claim 1, wherein the sharing options comprise options for:
limiting visibility of the order request to freight company partners that are within a specified geographic region;
delaying publishing the order request by a specified time period; and
specifying a default commission for the order request.

8. A freight management system for improving shipping transactions, the system comprising:
a memory; and
at least one processor coupled to the memory and configured to:
cause display of one or more freight companies to be considered to enter into a partnership agreement with a first freight company;
cause display of a first freight company user interface to be interfaced by a first freight company;
cause display of a second freight company user interface to be interfaced by a second freight company;
transmit, from the first freight company user interface of the freight management system, a partnership request to the second freight company user interface, wherein:
the first freight company is designated a shipping role of any one of a shipper, a carrier, a receiver, or a broker; and
the second freight company is designated a shipping role of any one of the shipper, the carrier, the receiver, or the broker that is not the role designated of the first freight company;
transmit, from the first freight company user interface, first sharing options to the second freight company user interface, the first sharing options limiting an amount of information controlled by the first freight company to be viewable by the second freight company;
in response, transmit acceptances of the partnership request and the first sharing options to the first freight company user interface;
transmit, from the second freight company user interface, second sharing options to the first freight company user interface, the second sharing options limiting an amount of information controlled by the second freight company to be viewable by the first freight company;
transmit, from the first freight company user interface, acceptance of the second sharing options to the second freight company user interface; and
transmit an order request for conducting a shipping transaction to the second freight company user interface that is prioritized in favor of the second freight company over other freight companies among the one or more freight companies that have not accepted a partnership request from the first freight company.

9. The system of claim 8, wherein the processor is further configured to:
transmit, from the first freight company user interface, a second partnership request to a third freight company user interface of a third freight company among the one or more freight companies, wherein the third freight company is designated a shipping role of any one of the shipper, the carrier, the receiver, or the broker that is not the role designated of the first freight company;
transmit, from the first freight company user interface, third sharing options to the third freight company user interface, the third sharing options limiting a second amount of information controlled by the first freight company to be viewable by the third freight company;
in response, transmit acceptances of the second partnership request and the third sharing options to the first freight company user interface;
transmit, from the third freight company user interface, fourth sharing options to the first freight company user interface, the fourth sharing options limiting an amount of information controlled by the third freight company to be viewable by the first freight company; and
transmit, from the first freight company user interface, acceptance of the fourth sharing options to the third freight company user interface.

10. The system of claim 9, wherein the at least one process is further configured to:
transmit the order request to the third freight company; and
prioritize the order request in favor of the third freight company over the second freight company, based on a specified prioritized partnership hierarchy by the first freight company.

11. The system of claim 10, wherein prioritizing the order request in favor of the third freight company over the second freight company comprises:
causing display of the order request in the third freight company user interface while prohibiting display of the order request in the second freight company user interface; and
causing display of the order request in the second freight company user interface after a delay in time from causing display of the order request in the third freight company user interface.

12. The system of claim 10, wherein prioritizing the order request in favor of the third freight company over the second freight company comprises:
causing display of the order request in the third freight company user interface while prohibiting display of the order request in the second freight company user interface;
receiving a rejection notice from the third freight company user to not fulfill the order request; and
in response to the rejection, causing display of the order request in the second freight company user interface.

13. The system of claim 8, wherein the sharing options comprise options for:
allowing an order request for a shipping transaction to be displayed on specified freight company interfaces; and
allowing the order request to be redisplayed on freight company interfaces that are specified partners of the partners of the freight company initiating the order request.

14. The system of claim 8, wherein the sharing options comprise options for:
limiting visibility of the order request to freight company partners that are within a specified geographic region;
delaying publishing the order request by a specified time period; and
specifying a default commission for the order request.

15. A computer-readable medium having no transitory signals embodying instructions that, when executed by a processor, perform operations comprising:
causing display of one or more freight companies to be considered to enter into a partnership agreement with a first freight company;
transmitting, from a first freight company user interface, a partnership request to a second freight company user interface of a second freight company among the one or more freight companies, wherein:
the first freight company is designated a shipping role of any one of a shipper, a carrier, a receiver, or a broker; and
the second freight company is designated a shipping role of any one of the shipper, the carrier, the receiver, or the broker that is not the role designated of the first freight company;
transmitting, from the first freight company user interface, first sharing options to the second freight company user interface, the first sharing options limiting an amount of information controlled by the first freight company to be viewable by the second freight company;
in response, transmitting acceptances of the partnership request and the first sharing options to the first freight company user interface;
transmitting, from the second freight company user interface, second sharing options to the first freight company user interface, the second sharing options limiting an amount of information controlled by the second freight company to be viewable by the first freight company;
transmitting, from the first freight company user interface, acceptance of the second sharing options to the second freight company user interface; and
transmitting an order request for conducting a shipping transaction to the second freight company user interface that is prioritized in favor of the second freight company over other freight companies among the one or more freight companies that have not accepted a partnership request from the first freight company.

16. The computer readable medium of claim 15, wherein the operations further comprise:
transmitting, by the freight management system and from the first freight company user interface of the freight management system, a second partnership request to a third freight company user interface of a third freight company among the one or more freight companies, wherein the third freight company is designated a shipping role of any one of the shipper, the carrier, the receiver, or the broker that is not the role designated of the first freight company;
transmitting, by the freight management system and from the first freight company user interface, third sharing options to the third freight company user interface, the third sharing options limiting a second amount of information controlled by the first freight company to be viewable by the third freight company;
in response, transmitting acceptances of the second partnership request and the third sharing options to the first freight company user interface;
transmitting, from the third freight company user interface, fourth sharing options to the first freight company user interface, the fourth sharing options limiting an amount of information controlled by the third freight company to be viewable by the first freight company; and
transmitting, from the first freight company user interface, acceptance of the fourth sharing options to the third freight company user interface.

17. The computer readable medium of claim 16, wherein the operations further comprise transmitting the order request to the third freight company and prioritizing the order request in favor of the third freight company over the second freight company, based on a specified prioritized partnership hierarchy by the first freight company.

18. The computer readable medium of claim 17, wherein prioritizing the order request in favor of the third freight company over the second freight company comprises:
causing display of the order request in the third freight company user interface while prohibiting display of the order request in the second freight company user interface; and
causing display of the order request in the second freight company user interface after a delay in time from causing display of the order request in the third freight company user interface.

19. The computer readable medium of claim 18, wherein prioritizing the order request in favor of the third freight company over the second freight company comprises:
causing display of the order request in the third freight company user interface while prohibiting display of the order request in the second freight company user interface;
receiving a rejection notice from the third freight company user to not fulfill the order request; and
in response to the rejection, causing display of the order request in the second freight company user interface.

20. The computer readable medium of claim 15, wherein the sharing options comprise options for:
allowing an order request for a shipping transaction to be displayed on specified freight company interfaces;
allowing the order request to be redisplayed on freight company interfaces that are specified partners of the partners of the freight company initiating the order request.
limiting visibility of the order request to freight company partners that are within a specified geographic region;
delaying publishing the order request by a specified time period; and
specifying a default commission for the order request.
